(19) United States
(12) Patent Application Publication
(10) Pub. No.: US 2002/0112628 A1
(43) Pub. Date: Aug. 22, 2002

(54) Drying unit for printing presses

(76) Inventor: David Irick, Dallas, TX (US)

Correspondence Address: Michael W. Piper, Conley, Rose & Tayon, P.C., 5800 Granite Parkway, Suite 400, Plano, TX, 75024-6616, US

(21) Appl. No.: 09/790,028

(22) Filed: Feb. 20, 2001

(51) Int. Cl. B41F 35/00; B41L 41/00

(52) U.S. Cl. 101/424.1

(57) ABSTRACT

A drying unit with a control unit for use with small sheet-feed printing presses. The drying unit has a shell, with infrared heat elements positioned in the open bottom of the unit, at least one fan in the top of the unit, and a reflector between the heat elements and fan that reflects heat down onto the paper being dried and allows air being moved by the fans to circulate through openings in the reflector and onto the heat elements and paper. The heat elements are screwed into a socket on one end, and the sockets are secured to the reflector. The control unit allows the press operator to turn on and off and control the speed of the fans, and to turn on and off and control the heat of the heat elements in the drying unit. In another arrangement of the invention, one or more externally mounted adjustable speed fans connected to the drying unit by a blower hose are used instead of fans mounted integrally to the drying unit.

### TECHNICAL FIELD

The invention relates generally to drying ink on printed matter that is processed through a printing press and, more particularly, to the use of infrared dryers on a printing press to dry ink on printed matter.

### BACKGROUND

In the printing industry, it is normal for papers being delivered from a printing press to be placed in a stack at the delivery end of the printing press. This can result in a shadow from ink that has not completely dried being imprinted on to the back of the next piece of paper in the stack. This problem is known in the industry as “offset” or “ghosting”. Additionally, when paper has to be run through the printing press another time, such as to print impressions of another color of ink onto the paper, the first color of ink must be completely dry, or it will smear and smudge when it is run through the printing press again. To avoid offset, and to speed drying, a spray powder can be applied to a piece of paper as it is placed on the top of the stack, which will place enough of a space between the sheet and the next sheet placed on top of it to allow air to circulate, and the ink to dry.

There are a number of difficulties associated with using spray powders, however. The powder is very fine, and tends to disperse over a wide area, settling on the printing press and surrounding equipment. This can cause dust to come in contact with a variety of surfaces where it is not desirable that it be placed. In particular, the dust is attracted to lubricants used on mechanical parts of presses, which tends to negate the effectiveness of the lubricants, causing premature part wear and more frequent system breakdowns. Additionally, the powder may be an irritant to persons working around the press who inhale the powder being placed into the air.

Another disadvantage is that the powder does not actually dry the ink, but rather keeps the sheets of paper from physically touching each other, allowing air to circulate between the sheets and dry the ink. Air drying can be slow because the space between the sheets is small, and thus the actual air circulation is minimal. This results in a delay before the stack of printed paper can be run through the printing press a second time, or placed in other machinery, such as folders, drill presses, cutters, or wrappers and the like. Also, if the papers are going to be run through the press a second time, the presence of the powder coating on the surface to be printed interferes with the second color of ink being applied smoothly and cleanly on the paper.

Yet another difficulty encountered is that the powder layer being applied must be thick enough to keep the sheets of paper from actually contacting each other. Thus, the amount of powder to be sprayed must be varied depending on the type of paper used, and the type and quantity of ink used. This necessitates frequent guessing and adjustment by the press operator to determine and set the proper amount of powder to disperse, depending on the printing job being run, and often requires adjustment during the course of a printing job if the initial powder quantity is too much or too little. Also, because different powders are required with different types of ink, a printer must keep a variety of powders on hand to use with different printing jobs.

An alternative to spray powder depositors is to use infrared drying systems which actually evaporate the water in the ink being impressed on the paper before the next piece of paper is stacked on top of it. Infrared drying systems have several advantages over spray powder systems. There is no spray powder to coat machinery, persons and surrounding areas and interfere with equipment operation or human health. If the paper is to be run through the press another time for further printing, there will be no powder to interfere with the additional impression being made on the surface of the paper. Additionally, the infrared heat substantially evaporates the water in the ink being impressed onto the paper, so the next sheet of paper can be placed directly onto an imprinted sheet, and because the water is substantially evaporated, there will be no offset. Also, because the water is substantially evaporated from the ink as it is being laid down on the paper, the ink will dry more quickly, and the printed pieces of paper can be processed through the press or other processing machinery more quickly. Ultimately, this results in printing jobs being completed and delivered to customers in less time.

While infrared drying systems are commonly used on larger printing presses, it has previously been difficult to produce a drying unit that can be mounted on many of the smaller size sheet-feed printing presses. This is because standard infrared lamps used in the printing industry are too long to fit in the space available at the delivery end of smaller printing presses. Typically the space available in smaller presses is around four inches in length, or less. Attempts have been made to create driers that would fit in the space available by mounting standard lamps sideways. However, this limits the number of lamps that can be used, which limits the amount of heat that can be generated. In addition, sideways mounting of the lamps also limits the range of drier widths to the widths of available lamps. Moreover, positioning the lamps sideways requires complex mounting mechanisms.

If higher wattage infrared lamps are used to produce enough heat to evaporate the water from the ink, the infrared units tend to experience excessive localized heat build-up that causes a burn hazard for press operators, can melt electrical connections, and can even affect ink viscosity. Also, because paper dust is highly flammable, the excess heat build-up from the lights poses a risk that the paper dust that accumulates on a printing press while paper is being printed could combust. Additionally, these lamps were secured with a metal spring-like contact mechanism at both ends to provide electrical contact, and the metal tended to weaken when heated by the lamps, resulting in less secure connections and loose lamps. Because there were electrical connections at both ends of the lamps, a large amount of wiring was needed, which increased the risk of melting wiring connections under the high heat conditions.

In the prior art, a fan was mounted at one or both ends of the unit to draw air across the surface of the lamps in an attempt to reduce the heat build-up in and around the unit. However, this configuration did not generate a large volume of air movement, and it was found that insufficient cooling of the drying unit continued to occur, resulting in excessive heat build-up.

U.S. Pat. No. 4,809,608 to Wolnick discloses an infrared drying unit with the fans mounted above the lamps. However, due to the space limitations imposed by use of the larger lamps in that system, there was very little clearance between the fan and the reflector (typically less than ⅛ inch). This nominal clearance was found to cause inconsistent air circulation patterns, and the openings in the reflector through which air could flow had to be restricted accordingly. Consequently, the resulting cooling was limited. These fans, additionally, were not internal to the unit, required a complex mounting mechanism, and because of the cover along the backs of the fans, could draw in air only along the side and edges of the fans, further restricting the air flow and resultant cooling.

Attempts have also been made to place the drying mechanism closer to the actual printing portion of the press so the paper can be exposed to heat for a greater length of time, thus ensuring the water evaporates from the ink sufficiently before the next sheet is placed on top of it in the delivery mechanism at the end of the press. However, use of the high wattage infrared lamps in the vicinity of the ink well and impression rollers may generate excess heat that raises the temperature of the ink. This affects the viscosity of the ink, which can impact the quality of the impression the ink makes on the paper. Additionally, on some press arrangements, the excess heat can evaporate the water in the water system that is being used to mix water with the ink, which can also negatively impact the impression being made on the paper.

Therefore, what is needed is a system and method for drying ink being impressed on paper in small, sheet-feed presses that will fit in the space available at the delivery end of the press, or in the vicinity of the rollers, which will substantially evaporate the water from the ink as it is impressed on the paper, but that does not have excessive heat build-up that poses a temperature hazard and negatively impacts the quality of the ink being used to make impressions on the paper.

### SUMMARY

The drying unit of the present invention, accordingly, provides a drying unit that uses smaller infrared lamps that fit into the length available, are easier to install, and reduce heat build-up. The smaller infrared lamps result in a drier that is smaller than prior driers having the same heat output and thus capable of installation in smaller printing presses without loss of drying capacity. The drying unit may incorporate adjustable-speed fans behind the lamps to blow air onto the infrared lamps and the paper.

Use of the system of the present invention eliminates or reduces the need for powder spray mechanisms, avoiding the problems associated with those systems. The system of the present invention also employs a combination of features that reduce or dissipate heat build-up caused by infrared lamps, addressing the shortcomings that were previously found when use of infrared drying systems was attempted on small sheet-feed printing presses. Because adequate air flow is supplied, excessive heat build-up does not occur, reducing burn and fire hazards, preventing the ink from changing viscosity, and preventing evaporation of fluid in the water system.

The current invention discloses a drying apparatus comprising a shell that has a length, width, height, and facial area; a plurality of heat sources, each connected to a power supply at one end, having a major axis generally parallel to the length of said housing, and a minor axis; a reflector having a front and back, spaced behind said plurality of said heat sources and containing a plurality of openings therein; and at least one fan having a face placed behind said reflector and enclosed within said shell, said fan positioned such that in operation the flow from the fan passes through said openings in said reflector and blows past said plurality of heat sources.

The current invention also discloses a process of evaporating water from wet ink on printed matter delivered from printing presses, comprising the steps of positioning at least one drying apparatus on the printing press in proximity to the printed matter being delivered from said printing press; applying power to the heat sources in the drying apparatus to evaporate the water from said wet ink on the printed matter; and applying power to at least one fan in the drying apparatus to blow air onto the heat sources and the printed matter.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a perspective view of a model printing press, on the delivery end of which has been installed a drying unit and control module of the present invention;

FIG. 1B is a side view of a model printing press, showing the approximate alternative positions of drying units in the delivery end, and printing roller areas of a press;

FIG. 2 is an inverted side view of a drying unit of the present invention, showing the lamps in the bottom of the unit and the reflector, partially broken away to show some of the fans along the width of the top of the unit;

FIG. 3 is a partially broken away bottom view of a drying unit, showing the lamps and reflector, and some of the fans at the top of the unit;

FIG. 4 is a side elevation view of a drying unit showing the lamp mounting sockets along the side of the unit, the reflector, and the fans mounted to the top of the unit;

FIG. 5 is a side elevation view of a drying unit showing the lamp mounting sockets along the side of the unit, the reflector, and an external fan connected to the unit by means of a blower hose; and

FIG. 6 is a front view of the control unit used with the drying unit of the present invention.

### DETAILED DESCRIPTION

In this specification, the terms “length” and “width” are used in reference to an operator standing at the delivery end of the press. The term “length” refers to the length of the press, or paper coming towards the operator while the term “width” refers to the width across the unit. Therefore, when describing the drying unit, the term “length” means the space along the length of the press in which the drying unit can be installed, and the term “width” relates to the width of the delivery end of the press. Typically, the width of the drying unit is therefore greater than the length of the unit.

In the following discussion the same reference numerals will be used throughout to refer to the same or similar components. In the interest of conciseness, various other components known to the art, such as components of printing presses, ink, paper and the like, have not been generally shown or discussed. Although numerous specific details are set forth to provide a thorough understanding of the present invention, it will be obvious to those skilled in the art that the present invention may be practiced without such specific details.

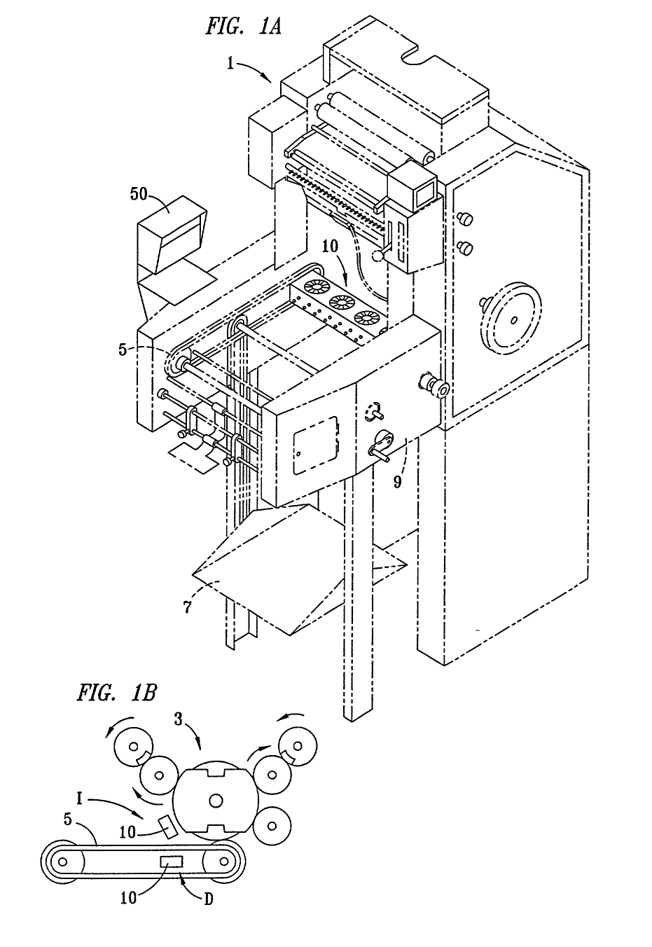

Referring to FIG. 1A of the drawings, a typical sheet fed press 1 is shown generally. A drying unit 10 and control unit 50 of the present invention are shown mounted on the press 1. As a piece of paper is printed, it comes out of the press 1 onto the carrier 5 and is carried onto the receiving unit 7 at the delivery end 9 of the press 1. In one arrangement of the present invention, the drying unit 10 is mounted at the delivery end 9 of the press 1. The drying unit 10 is secured to the press 1 by brackets or other means (not shown) that are tailored to work with each particular model of press 1. As the paper comes onto the carrier 5, it passes beneath the drying unit 10 and is dried as the infrared radiation from the heat source is projected down onto the paper along with heated air. The control unit 50 is also mounted on the delivery end 9 of the press 1 proximate to the drying unit 10 such that the press operator can access the controls. Details of the drying unit 10 and control unit 50 are explained more fully below. Details about operation of the printing press 1 are considered to be known to those skilled in the art and no further description is considered necessary.

FIG. 1B of shows some alternate mounting positions for the drying unit 10 on the press 1. Typically, only a single drying unit is installed on a given printing press. The drying unit 10 can be mounted either just beyond the rollers 3 of the press 1 (shown at location I), or in the delivery end of the press 9 (shown at location D), as depicted in FIG. 1A. Installation at location D is considered typical while installation at location I offers advantages in some situations. In some configurations of the present invention, drying units 10 may be placed in both positions depicted herein. Drying units 10 may also be placed near the transfer cylinder.

FIG. 2 provides a bottom-side view of an assembled drying unit 10. The drying unit 10 consists of a shell 12, into which is secured a reflector 14 containing multiple openings 15, one or more fans 16, and a number of heat element sockets 18 and infrared heat elements 20. The shell has a length L, a width W, a height H, and a facial area F. The fans 16 move air down through the openings 15 in the reflector 14 past the infrared heat elements 20 to cool the interior of the shell 12, and disperse the heat and hot air generated by the heat elements 20, preventing excessive heat buildup.

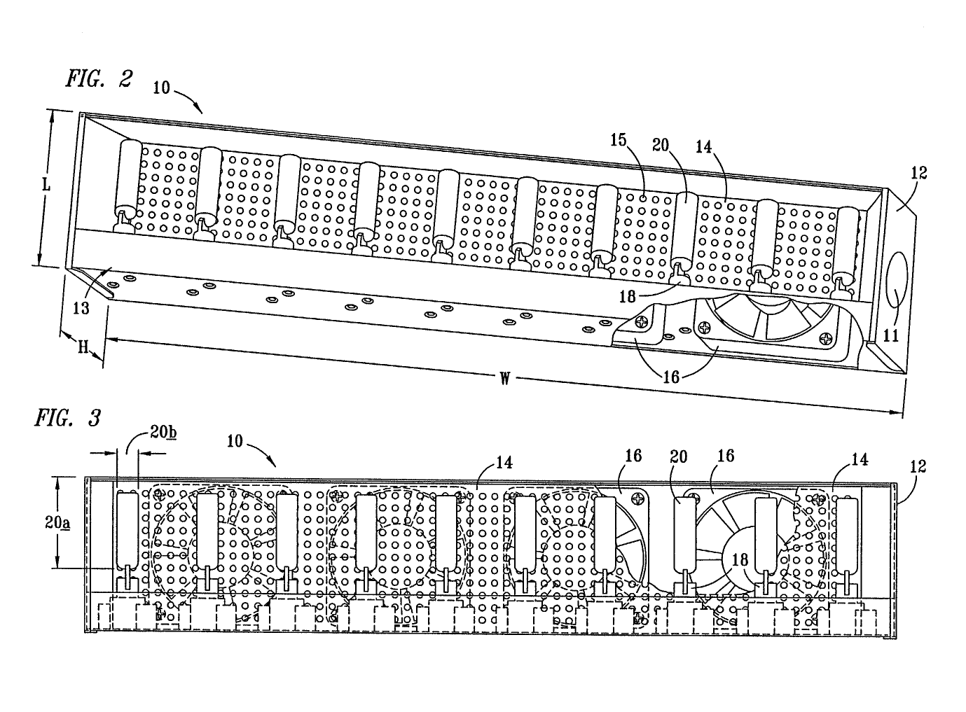

As shown in FIGS. 2, 3, and 4, the shell 12 is generally rectangular in shape, and may have a hole 11 cut in either or both ends in the top portion of the shell above the reflector. The shell 12 has a passageway 13 along the width of one edge on the bottom. The remainder of the bottom of the shell 12 is open so the infrared heat from the heat elements can be projected down onto the paper. The passageway 13 encloses and protects the heat element sockets 18 and their associated wiring.

The reflector 14 is perforated with openings 15 to allow air to flow from the fans 16 through the reflector 14 past the heat elements 20 at the bottom of the drying unit 10. The face of the fan 16a faces toward the back of the reflector 14b. The reflector 14 runs the length and width of the shell 12 in approximately the center of the height of the shell 12. The reflector 14 has a front 14a, which is typically reflective, and a back 14b. The shell 12 and reflector 14 are preferably stamped from 0.032 inch thick aluminum sheet metal. Aluminum is an excellent heat conductor (typically 137 BTU/hr FT °F.), which promotes ease of heat transfer in the drying unit 10. This preferred material is commonly used in high voltage systems, and is designated by NEMA and ASTM as GPO-3. Other materials, such as stainless steel can also be used, but are not as good at conducting heat (typically 10 BTU/hr FT °F.). Generally, the reflector surface facing the heat elements 20 is selected to be reflective of the infrared radiation emitted by the heat elements 20.

The sockets 18 are bolted to the reflector 14 by machine screws inserted through drilled holes in the reflector 14, into holes in the socket 18 flanges. The infrared heat elements 20 are screwed into the sockets 18. The heat elements 20 have a major axis 20a and a minor axis 20b. The preferred sockets 18 are manufactured by CEW, Model CEWB32. The preferred heat elements 20 used in the present invention are 500 watts each, manufactured by CEW, Model 500QCLMC-230V. The heat elements are of translucent glass with a threaded screw unit at one end that threads into the socket 18. A variety of other sizes and wattage of heat elements are available starting at a minimum of 50 watts and one inch in length, and can be used as appropriate.

The fans 16 are secured along the width of top portion of the shell 12 by machine screws inserted through drilled holes in the shell 12, through spacers inserted between the fans 16 and the shell 12, through holes in the fan flanges, and are secured by lock washers and nuts. Openings in the shell 12 correspond with each fan 16 mounted in the shell 12. The preferred fans 16 are an Orion Model OD9225-24HB.

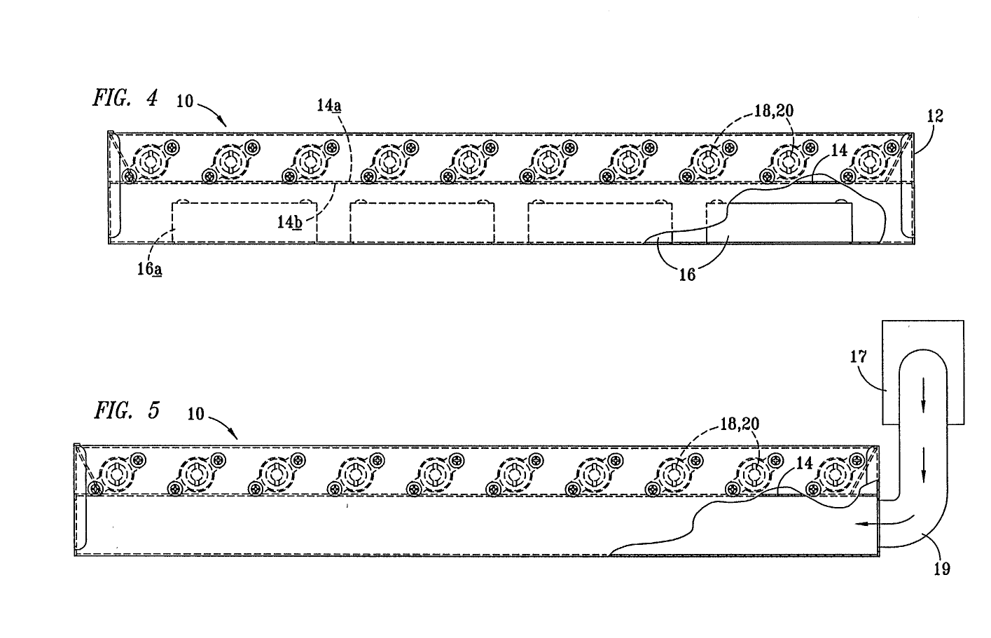

As can be clearly seen in FIG. 4, there is a gap about ½ the width of the fans between the fans 16 and the reflector 14. This allows for adequate air circulation through and around the fans such that air can be drawn through the openings 15 in the reflector 14 and past the lamps 20.

In the arrangement of the drying unit 10 shown in FIGS. 2, 3 and 4, there are four fans 16 mounted along with width of the top portion of the shell 12, with four holes (not shown) cut into the shell for the fans, and ten sockets 18 secured to the width of the shell 12 in the bottom portion of the unit.

FIG. 5 shows another arrangement of the drying unit 10, where fans 16 are not contained within the unit, but instead at least one external adjustable speed fan 17 is installed remotely from the drying unit 10, and connected thereto by means of a blower hose 19. The fan blows air down onto the lamps and paper.

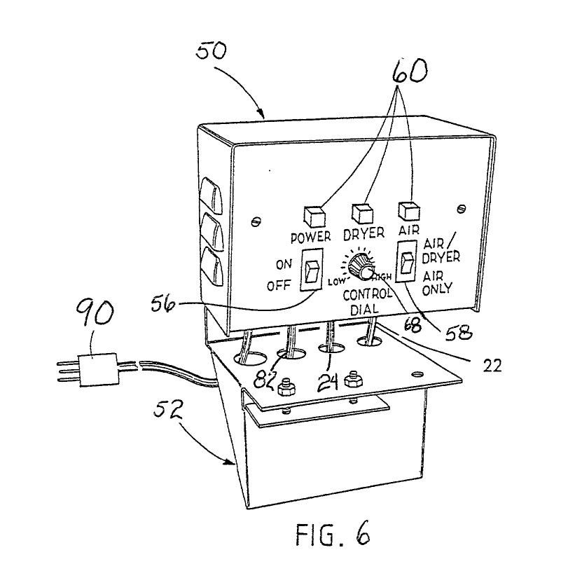

FIG. 6 shows the control unit 50 mounted to the press by means of a mounting bracket 52. Power cord 22 from the sockets 18 and power cord 24 from the fans are fed into the control unit 50 through holes in the bottom of the control unit 50 and are connected to a terminal board 54(not shown) inside the control unit 50. The control unit 50 has an On/Off power switch 56, and a multi-position switch 58, that enables the operator to turn on the heat elements 20 and fans 16 for the drying unit 10, or to turn on just the fans 16 for the drying unit 10. The control unit 50 has indicator lights 60 that indicates whether power is applied to the drying unit 10, whether the heating elements 20 are on, and whether the fan(s) 16 are on. More than one of these indicator lights may be illuminated at one time, as needed to indicate the current state of the drying unit 10.

The control unit 50 may have a control dial 68 that controls the amount of infrared radiation delivered by the heating elements 20 in the drying unit 10. Another control dial 68 may be used to control the speed of the fans 16, which regulates the volume of air being flowed over the lamps 20.

A heat sensor (not shown) is mounted to the back of the control unit 50, and is connected to the control unit 50 by means of a cord 82 attached to the heat sensor. Cord 82 from the heat sensor is fed into the control unit 50 through a hole in the bottom of the control unit 50 and is connected to a terminal board 54(not shown) inside the control unit 50. If the temperature in the area of the heat sensor exceeds a safe level, the heat elements 20 will be automatically turned off. When the temperature in the area of the heat sensor returns to an acceptable level, the heat elements 20 will resume operation.

The control unit 50 is preferably connected to the local commercially available alternating current power source as needed through power cord 90, which provides power to operate the control unit 50, the heat elements 20, and fans 16 of the drying unit by means of power cords 22 and 24, and the heat sensor by means of power cord 82.

The infrared lamps 20 used in the present invention are shorter than the lamps typically used in the printing industry. The infrared lamps 20 used in the present invention mount at only one end, and screw into a socket 18 like a typical lamp light bulb. These shorter lamps fit into the short space available at the delivery end of the printing press, typically 4 inches in length or less. For example, a lamp 20 used in one arrangement of the present invention is approximately 3-½ inches long, inclusive of the socket 18, and generates 500 watts of energy. The old style of lamps were approximately four inches long, and when mounted in the mounting mechanisms, were approximately six or more inches in length.

Typically, the output of an infrared drying unit is measured in watts/inch, calculated by dividing the output of the heat sources by with width of the drying unit. By using these shorter lamps 20, more lamps can be arranged in a smaller area, which allows a greater number of watts of output per area, resulting in a drying unit 10 with greater output of heat. Typically, at least 100 watts/inch can be generated using the drying unit 10 of the present invention. Additionally, the drying unit 10 of the present invention may provide a mechanism 68 that allows the operator to control the intensity generated by the lamps.

The adjustable speed fans 16 in the present invention are mounted behind the lamps 20, enabling more airflow to be directed onto the lamps 20, helping to reduce the heat build-up. The fans 16 used in the present invention are mounted inside the top width of the shell 12, in an area referred to as the plenum, and force air through the openings in the reflector 14 and onto the lamps 20, which helps to disperse the heat generated. The fans 16 are aimed at the reflector 14 that is positioned directly above the infrared lamps 20, placing air where it is most effective, serving to cool the interior of the shell 12 and disperse the heat and heated air generated down onto the paper. In an alternative arrangement of the present invention, one or more external adjustable speed fans 17 can be connected to a blower hose 19 which is connected to the drying unit 10, rather than fans 16 being mounted inside the drying unit 10 to provide air to the drying unit 10.

The present invention allows the fans 16 to be placed at least ¼ inch, and typically ½ inch to 1 inch back from the reflector 14. This spacing is sufficient to provide consistent air circulation patterns, as a result of which the reflector 14 can be perforated in many places 15, and a large volume of air can be moved through the fans 16 and onto the lamps 20, allowing for more rapid heat dispersion.

Yet another advantage of the present invention is that in some arrangements, the speed of the fans 16 can be controlled, or varied, to further regulate the amount of airflow that occurs at any time. Being able to control the speed of the fans 16 allows greater control of the temperature of the drying unit 10 and the air current being created. Varying the drying temperature can help ensure proper drying for each particular printing job. Regulating the fan 16 speed can help to increase air flow, or decrease it as needed to circulate more air or allow greater heat build up to further regulate drying.

Still another advantage of the present invention may include a heat sensor that will automatically shut off the lamps 20 of the drying unit 10 if the temperature of the drying unit 10 becomes too hot. When the sensor has cooled down to an acceptable temperature, the drying unit 10 will be allowed to operate again. One configuration of the present invention incorporates a shutoff mechanism that is tied into the printing press 1, and will shutoff the drying unit 10 when the press 1 is shut down by the press operator for any reason. This prevents excess heat being applied to the sheet of paper that is on the top of the stack when the press 1 is shut off. Another configuration of the present invention may have a multiposition switch 58 that allows the operator to turn on both the lamps 20 and the fans 16, or just the fans 16. For certain printing jobs, the air circulated by the fans 16 may provide sufficient drying, without the need for use of the lamps 20.

It is understood that the present invention can take many forms and embodiments. Accordingly, several variations may be made in the foregoing without departing from the spirit or the scope of the invention. Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

I claim:

1. A drying apparatus comprising:
a) a shell having a length, width, height, and facial area;
b) a plurality of heat sources having a major axis and a minor axis;
each one of said plurality of heat sources having its major axis oriented generally parallel to the length of said housing;
each one of said plurality of heat sources having a connection to a power supply at only one end;
c) a reflector having a front and back, spaced behind said plurality of said heat sources and containing a plurality of openings therein; and
d) at least one fan having a face placed behind said reflector and enclosed within said shell, said fan positioned such that in operation the flow from the fan passes through said openings in said reflector and blows past said plurality of heat sources.

2. The apparatus according to claim 1 wherein each one of said plurality of heat sources have a length along their major axis that is not greater than four inches.

3. The apparatus according to claim 1 wherein the length of the shell is not greater than four inches.

4. The apparatus according to claim 1 wherein the distance from the face of the fan to the back of the reflector is at least ¼ inch.

5. The apparatus according to claim 1 wherein the distance from the face of the fan to the back of the reflector is not more than two inches.

6. The apparatus according to claim 1 wherein said plurality of heat sources are spaced apart by at least ½ inch.

7. The apparatus according to claim 1 wherein said width of said housing is greater than said length of said housing.

8. The apparatus according to claim 1 wherein said reflector is made of a reflective material.

9. The apparatus according to claim 1 wherein the total power from all of said plurality of heat sources divided by the width of said housing is at least 100 watts/inch.

10. The apparatus according to claim 1 further comprising a control unit for controlling said drying apparatus comprising:
a) a means for energizing said plurality of heat sources, said at least one fan, and said control unit;
b) a means for controlling the amount of power provided to said plurality of heat sources;
c) a means for controlling the speed of said at least one fan;
d) a means for connecting said control unit to a power source;
e) a means for connecting said control unit to said plurality of heat sources; and
f) a means for connecting said control unit to said at least one fan.

11. The control unit according to claim 10 further comprising a means for automatically shutting off said plurality of heat sources when the temperature in the vicinity of said control unit reaches a pre-determined temperature.

12. The apparatus according to claim 1 wherein each of the plurality of heat sources is generally cylindrical in shape and has an electrical contact at one end of said heat source.

13. The apparatus according to claim 12 wherein each of said plurality of heat sources is secured into a socket by means of said electrical contact at said one end of said heat source.

14. The apparatus according to claim 1 wherein said at least one fan is replaced by at least one externally positioned fan connected to said drying apparatus by means of a blower hose.

15. A process of evaporating water from wet ink on printed matter delivered from printing presses, comprising the steps of:
a) positioning a heating apparatus on the delivery end of said printing press above where said printed matter is delivered from said printing press;
b) applying power to a plurality of heat sources in said heating apparatus to evaporate water from said wet ink on said printed matter;
c) applying power to at least one fan in said heating apparatus to blow air down onto said plurality of heat sources and onto said printed matter;

16. The process according to claim 15 wherein a reflector is positioned between said plurality of heat sources and said at least one fan, said reflector reflecting heat from said heat sources down onto said printed matter, and containing a plurality of perforations through which said at least one fan blows air onto said heat sources.

17. The process according to claim 15 wherein the power applied to said plurality of heat sources can be varied.

18. The process according to claim 15 wherein said power to said at least one fan can be regulated to control the speed of said at least one fan.

19. The process according to claim 15 further comprising stopping the application of power to said heat sources when said heating apparatus reaches a pre-determined temperature.

20. The process according to claim 15 wherein said at least one fan in said heating apparatus is replaced by at least one fan located externally to said heating apparatus and connected thereto by means of a blower hose.

21. A process of evaporating water from wet ink on printed matter delivered from printing presses, comprising the steps of:
a) positioning at least one heating apparatus on the printing press in proximity to the printed matter being delivered from said printing press;
b) applying power to a plurality of heat sources in said at least one heating apparatus to evaporate said water from said wet ink on said printed matter;
c) applying power to at least one fan in said heating apparatus to blow air onto said plurality of heat sources and onto said printed matter;

22. The process according to claim 21 wherein a reflector is positioned behind said plurality of heat sources, said reflector reflecting heat from said heat sources down onto said printed matter, and containing a plurality of perforations through which said at least one fan blows air onto said heat sources.

23. The process according to claim 21 wherein the power applied to said plurality of heat sources can be varied.

24. The process according to claim 21 wherein said power to said at least one fan can be regulated to control the speed of said at least one fan.

25. The process according to claim 21 further comprising stopping the application of power to said heat sources when said heating apparatus reaches a pre-determined temperature.

26. The process according to claim 21 wherein said at least one fan in said heating apparatus is replaced by at least one fan located externally to said heating apparatus and connected thereto by means of a blower hose.
